(19) United States
(12) Patent Application Publication
(10) Pub. No.: US 2013/0090983 A1
(43) Pub. Date: Apr. 11, 2013

(54) SYSTEM AND METHOD FOR TIERED OFFER FORECASTING

(71) Applicant: Revionics, Inc., Roseville, CA (US)

(72) Inventors: Jeffrey Moore, Phoenix, AZ (US); John Douglas Evans, Phoenix, AZ (US)

(73) Assignee: REVIONICS, INC., Roseville, CA (US)

(21) Appl. No.: 13/645,257

(22) Filed: Oct. 4, 2012

Related U.S. Application Data
(60) Provisional application No. 61/544,085, filed on Oct. 6, 2011.

(51) Int. Cl. G06Q 30/02

(52) U.S. Cl. 705/7.31

(57) ABSTRACT

A tiered offer forecasting process is performed on a system executing code contained on a computer-readable storage medium. The process includes receiving purchase records for a product, each of the purchase records including a basket count identifying a quantity of the product purchased and a unit price identifying a purchase cost for the product. Pricing for a tiered offer is received. The pricing includes a first offer price for the product at a first tier, a second offer price for the product at a second tier, and a tier breakpoint differentiating the first tier from the second tier. Consumer acceptance of each of the first and second offer prices is ascertained. The consumer acceptance is utilized to forecast quantities of sales of the product at each of the first and second offer prices. This forecast of sales is provided to a user for implementation in the tiered offer.

### TECHNICAL FIELD OF THE INVENTION

The present invention relates generally to sales promotion forecasting and optimization. More specifically, the present invention relates to tiered offer forecasting.

### BACKGROUND OF THE INVENTION

Pricing strategy is an important consideration for successful retailers. In order to improve revenue, profit, and customer loyalty, successful retailers plan the best strategies, including setting optimal base pricing, executing promotional events, and executing markdown events. One exemplary promotional event is through tiered pricing. In tiered pricing, multiple price points for a product may be offered for a consumer to consider. A “tiered offer” is defined as an offer to a customer that presents an additional incentive for purchasing a greater amount of the same product. This type of incentive structure is commonly used to increase consumer purchase amounts.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a block diagram of a system for forecasting sales of a product in a tiered offer in accordance with an embodiment;

FIG. 2 shows a flowchart of a tiered offer forecasting process executed by the system of FIG. 1;

FIG. 3 shows a diagram of purchase records used to illustrate an exemplary execution of the tiered offer forecasting process;

FIG. 4 shows a bar chart of a distribution of basket counts determined from transaction log data;

FIG. 5 shows a diagram exemplifying basket count, frequencies, and an average unit price for a product;

FIG. 6 shows a graph depicting an incentive curve established through execution of the tiered offer forecasting process;

FIG. 7 shows a graph depicting use of the incentive curve to ascertain an consumer acceptance value of a tiered offer;

FIG. 8 shows a diagram exemplifying computation of a nominal incentive value in accordance with the tiered offer forecasting process;

FIG. 9 shows a diagram exemplifying computation of a nominal probability value in accordance with the tiered offer forecasting process;

FIG. 10 shows a diagram summarizing of a first and second incentive values for determining the incentive curve of FIG. 6 in accordance with the tiered offer forecasting process;

FIG. 11 shows a diagram exemplifying computation of an offer incentive value in accordance with the tiered offer forecasting process;

FIG. 12 shows a diagram exemplifying computation of a consumer acceptance value in accordance with the tiered offer forecasting process;

FIG. 13 shows a diagram exemplifying generation of a weighted offer price in accordance with the tiered offer forecasting process;

FIG. 14 shows a diagram demonstrating a portion of computations performed in accordance with the tiered offer forecasting process for an exemplary tiered offer scenario;

FIG. 15 shows a diagram demonstrating a remaining portion of computations performed in accordance with the tiered offer forecasting process for the exemplary tiered offer scenario of FIG. 14;

FIG. 16 shows a graph depicting an incentive curve in accordance with an example;

FIG. 17 shows a chart of an empirical count distribution used to derive the graph of FIG. 16;

FIG. 18 shows a graph depicting an incentive curve in accordance with another example;

FIG. 19 shows a chart of an empirical count distribution when there is no history of incentive at higher basket counts;

FIG. 20 shows graph depicting an incentive curve derived using the empirical count distribution of FIG. 19 and using a three-fer offer structure;

FIG. 21 shows a chart of an empirical count distribution when there is no history of incentive at higher basket counts; and

FIG. 22 shows graph depicting an incentive curve derived using the empirical count distribution of FIG. 20 and using a two-fer offer structure;

### DETAILED DESCRIPTION

Promotion optimization is a key success factor for increasing consumer traffic and defeating competitors in the consumer market. Indeed, retailers are promoting their products at an unprecedented rate, driven by the need to discount in order to drive consumer traffic and hold off the competition. Pressure from vendors to promote certain brands adds to the complexities in delivering effective promotions.

Tier pricing is a promotional tool that allows a retailer to price items differently for higher quantities. In a “tiered offer,” a product may be offered at a single unit price of, for example, $1.00, or the product may be offered at a two unit price of, for example, two for $1.50. In this example, a consumer who purchases two of the product instead of one receives a twenty five percent reduction per product in exchange for purchasing the greater amount. This type of promotional incentive structure is typically used to move more merchandise by increasing customer purchase amounts.

Embodiments entail a system, a computer-readable storage medium containing executable code, and methodology for predicting, i.e., forecasting, sales of a product in a tiered offer. In particular, the system and methodology entails an approach for forecasting of tiered offers. The approach calls for analyzing historical transaction data to produce an empirical distribution of basket counts and associated price/promotion data, and leveraging this historical transaction data to forecast quantities of products sold by offer tier, as a function of a price incentive and purchase amount associated with each tier. Retailers can use the knowledge of sales forecasting in a tiered offer to determine which tiered offer will increase consumer traffic and/or maximize profits, how much inventory to stock, what employment levels to maintain, and so forth.

Distinction can be made between “enforced” offer tiers and “unenforced” offer tiers. When a retailer presents a tiered offer that results in a per unit price that is less when buying multiple units, but always charges the lower price per item even if the consumer purchase only one unit, then the offer is said to be unenforced. If, however, the consumer buying only one item is charged the higher per unit price, then the offer is said to be enforced. The system and method discussed herein presumes enforcement of the enforced tiered offer structure. However, the system and method can be utilized to predict, i.e., forecast, tiered purchase behavior regardless of enforcement of the tiered offer structure.

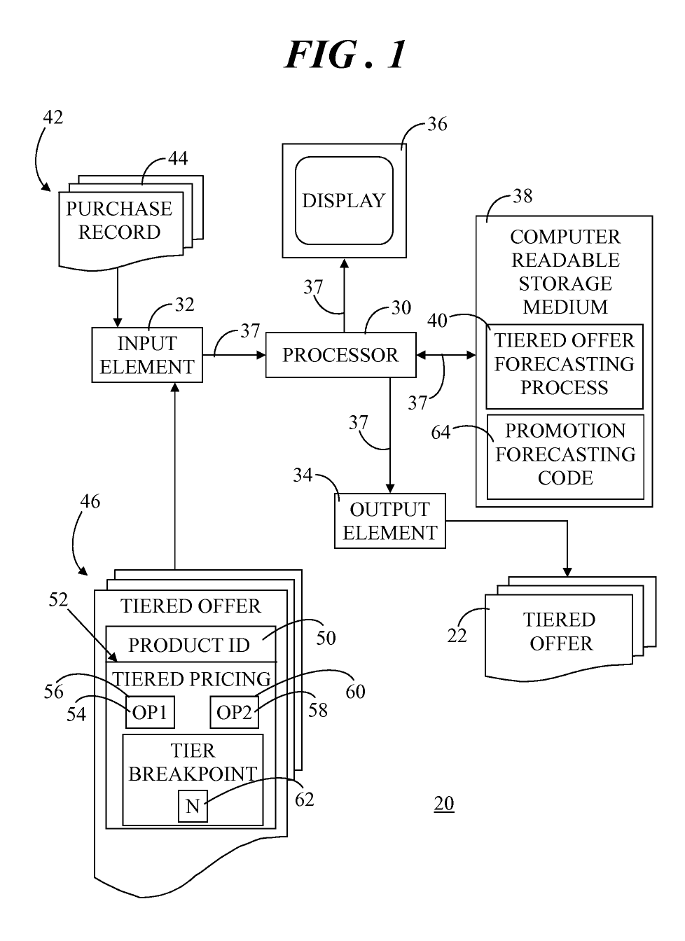

FIG. 1 shows a block diagram of a computing system 20 for forecasting sales of a product in a tiered offer 22 in accordance with an embodiment. Tiered offer 22 refers to the approach of offering a product at differing prices as a function of a quantity of the product that a consumer purchases. Thus, a consumer realizes greater cost savings when purchasing a greater quantity of a product. The following discussion pertains to the offering of a single item or product. However, the forecasting approached described herein can pertain equivalently to a price family of products in order to account for the conventional ability of consumers to purchase any combination of products within a price family to meet the designated purchase quantity minimum (i.e., tier).

Computing system 20 includes a processor 30 on which the methods according to the invention can be practiced. Processor 30 is in communication with an input element 32, an output element 34, and a display 36. These elements may be interconnected by a bus structure 37.

Input element 32 can encompass a keyboard, mouse, pointing device, audio device (e.g., a microphone), and/or any other device providing input to processor 30. Output element 34 can encompass a printer, an audio device (e.g., a speaker), and/or other devices providing output from processor 30. Input and output devices 32 and 34 can also include network connections, modems, or other devices used for communications with other computer systems or devices via a communication network (not shown) such as an organization specific intranet or the ubiquitous Internet.

Computing system 20 also includes a computer-readable storage medium 38 in communication with processor 30. Computer-readable storage medium 38 may be a magnetic disk, compact disk, or any other volatile or non-volatile mass storage system readable by processor 30. Computer-readable storage medium 38 may also include cooperating or interconnected computer readable media, which exist exclusively on computing system 20 or are distributed among multiple interconnected computer systems (not shown) that may be local or remote.

Tiered offer forecasting code 40 is stored on computer-readable storage medium 38 and is executed by processor 30. In general, tiered offer forecasting code 40 instructs processor 30 to evaluate various price offers for a product in a tiered offer to ascertain consumer acceptance of the tiered offer. Tiered offer forecasting code 40 uses transaction log data of purchases made of a product in order to forecast sales for a future tiered offer 22. Of particular interest for input into tiered offer forecasting code 40 executed at computing system 20 is transaction log data 42 in the form of a plurality of purchase records 44. Purchase records 44 may be received from a plurality of brick-and-mortar stores for the retailer, from an online retailer site, and so forth for receipt at computing system 20 via input element 32.

A user, e.g., pricing manager, for a retailer can provide inputs for evaluation in tiered offer forecasting code 40. Such user provided inputs can include tiered offer scenarios 46. A tiered offer scenario 46 can identify at least one product or product family 50 associated with tiered pricing 52. Tiered pricing 52 can include a first offer price 54 (OP1) for product 50 at a first tier 56 and a second offer price 58 (OP2) for the same product 50 at a second tier 60. First and second tiers 56 and 60, respectively, define a quantity of products 50 that a consumer must purchase in order to receive the corresponding first offer price 54 or second offer price 58 for that tier. For example, first offer price 54 of first tier 56 may define the purchase price of a single unit of product 50 (e.g., 1 for $1.00) and second offer price 58 may define the purchase price of three or more units of product 50 (e.g., 3 for $2.00).

A user may also specify a tier breakpoint 62 that differentiates first tier 56 from second tier 60. In an embodiment, tier breakpoint 62 identifies the minimum number of units of product 50 that a consumer must purchase in order to receive second offer price 58 of second tier 60. As an example, tiered offer 46 with a price reduction when buying three or more units of product 50 would have a tier breakpoint 62 value of three (N=3).

Tiered offer forecasting code 40 can be employed as an adjunct to promotion forecasting code 64 in which price offers may not be split into multiple tiers. Tiered offer forecasting code 40 and promotion forecasting code 64 will be described in greater detail below. Execution of tiered offer forecasting code 40 can produce multiple tiered promotion offers 22 that are provided to a retailer or pricing manager for determining which tiered offer may yield the most favorable results in terms of, for example, increased consumer traffic, increased movement or merchandise, and/or maximized profits.

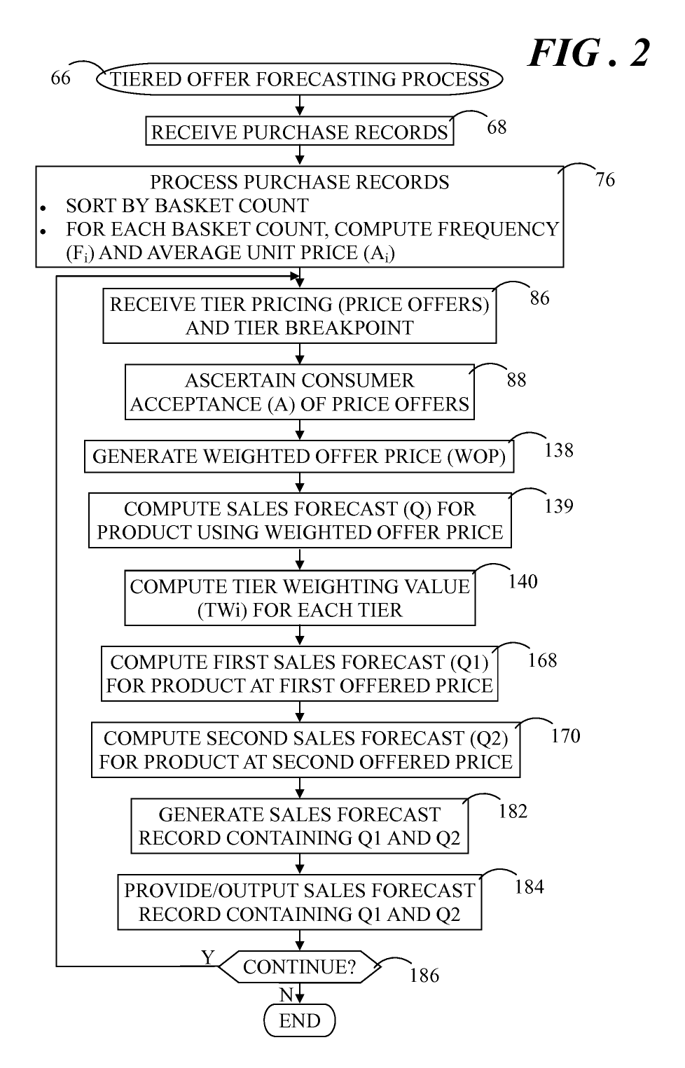

FIG. 2 shows a flowchart of a tiered offer forecasting process 66 executed by computing system 20 (FIG. 1). Process 66 describes computer-assisted methodology for forecasting sales of product 50 (FIG. 1) in one or more tiered offer scenarios 46 (FIG. 1) for provision to a retailer as a tiered offer 22 (FIG. 1) that can be implemented by a retailer.

Tiered offer forecasting process 66 begins with a task 68. At task 68, computing system 20, executing tiered offer forecasting code 40 (FIG. 1), receives transaction log data 42 (FIG. 1) containing purchase records 44 (FIG. 1).

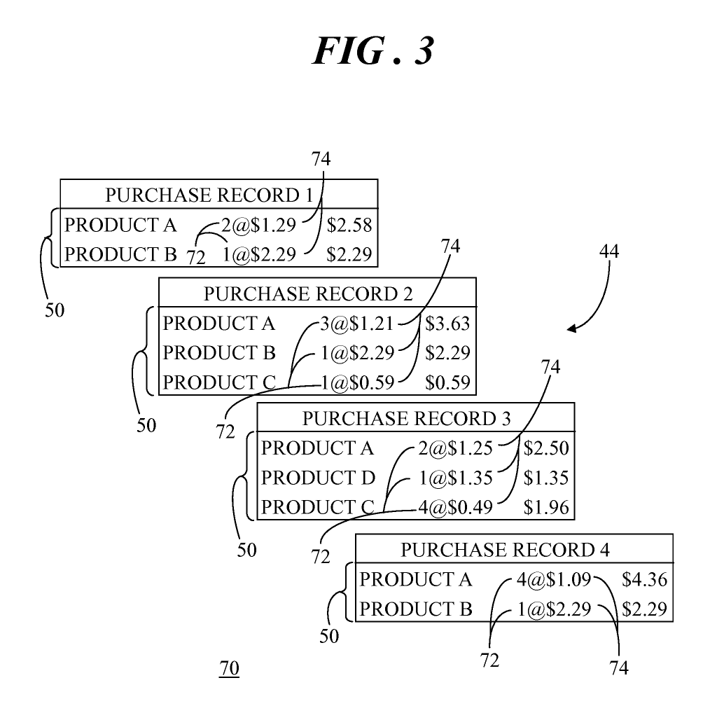

Referring to FIG. 3 in connection with task 68, FIG. 3 shows a diagram 70 of purchase records 44 used to illustrate an exemplary execution of tiered offer forecasting process 66. Diagram 70 includes a set of four purchase records 44. Each purchase record 44 includes a list or “basket” of products 50 that a consumer purchased. Each purchase record 44 additionally includes a quantity for each product that the consumer purchased, referred to herein as a basket count 72, and a unit price 74 identifying a purchase cost for each product 50. An example of purchase records 44 is the itemized receipt that a consumer receives when shopping in a retail facility. Such a receipt lists all of the product types and quantities of products purchased, and the prices paid for those products.

The term “basket” refers to the idea of a shopping cart or a shopper's basket. Thus, the term “basket count” refers to the number of units of the same product 50 that are bought together. By way of example, referring to a first purchase record 44, labeled “PURCHASE RECORD 1,” if a consumer purchases two units of a PRODUCT A and one unit of a PRODUCT B, then basket count 72 for PRODUCT A is two and basket count 72 for PRODUCT B is one. Thus, purchase records 44 represent historical data, i.e., past purchases, for a plurality of consumers.

Referring back to tiered offer forecasting process 66 (FIG. 2), following the receipt of purchase records 44 at task 68, process 66 continues with a task 76. At task 76, the received purchased records are processed. Processing entails sorting purchase records 44 by basket count 72 (FIG. 3), computing a frequency of that basket count 72 and computing an average unit price for that basket count 72.

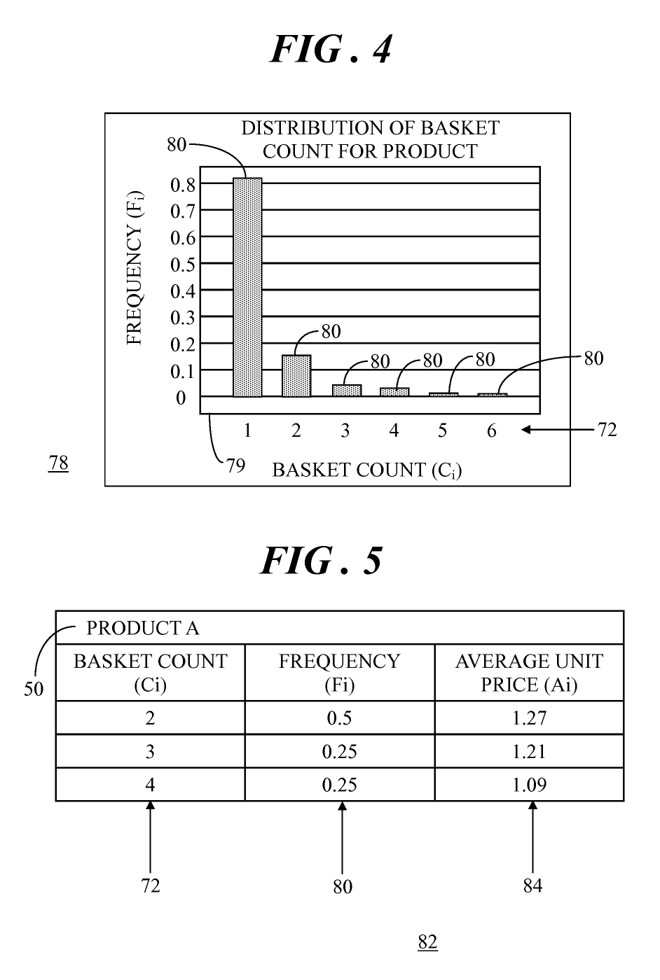

Referring to FIG. 4 in connection with task 76, FIG. 4 shows a bar chart 78 of a distribution of basket counts 72 determined from transaction log data, e.g., purchase records 44, and their corresponding frequencies 80. Bar chart 78 provides a visual representation of categorical data. In this case, the categorical data is the purchase records 44 sorted by basket count 72, i.e., the quantity of units of product 50 purchased, in each purchase record 44.

Bar chart 78 represents a scenario in which basket counts 72 (Ci) are one through six and distributed along a horizontal axis 79 of diagram 78. That is, some consumers purchased one unit of product 50 (i.e., basket count 72 is equal to one), some consumers purchased two units of product 50, (i.e., basket count 72 is equal to two). Still other consumers purchased three units of product 50, (i.e., basket count 72 is equal to three), and so forth.

A vertically oriented rectangular bar associated with each basket count 72 represents a frequency 80 (Fi), or proportion, of purchase records containing the quantity of product 50 purchased equal to basket count 72. For example, frequency 80 for basket count 72 of 1 is approximately 0.8 indicating that approximately 80% of purchase records 44 contained a purchased unit quantity of one of product 50. Similarly, frequency 80 for basket count 72 of 2 is approximately 0.15, indicating that approximately 15% of purchase records 44 contained a purchased unit quantity of two of product 50.

Referring to FIG. 5 in connection with task 76, FIG. 5 shows a diagram 82 exemplifying basket count 72, frequencies 80, and an average unit price 84 for product 50, identified as PRODUCT A, in the exemplary purchase records 44 of FIG. 3. Basket count 72 identified the quantity of products 50 purchased at one time. In this example, there were basket counts 72 of two, three, and four. Frequencies 80 indicate how often a particular basket count 72 occurs. One half of purchase records 44 included a quantity of two products 50 (i.e., Fi=0.5 at Ci=2), while one quarter of purchase records 44 included a quantity of three products 50 (i.e., Fi=0.25 at Ci=3), and another quarter of purchase records 44 included a quantity of fourth products 50 (i.e., Fi=0.25 at Ci=4).

At each basket count 72, average unit price 84 is computed. The term “average unit price” refers to the average price paid for the products at each basket count 72. Thus, average unit price 84 for basket count of two is $1.27 (i.e., Ai=1.27 at Ci=2), average unit price 84 for basket count 72 of three is $1.21 (i.e., Ai=1.21 at Ci=3), and average unit price 84 for basket count 72 of four is $1.09 (i.e., Ai=1.09 at Ci=3). Frequencies 80 and average unit prices 84 at each basket count 72 are used as base data for evaluating tiered offers 46 (FIG. 1).

Referring back to tiered offer forecasting process 66 (FIG. 2), following purchase record processing task 76, process 66 continues with a task 86. At task 86, computing system 20 (FIG. 1) receives tier pricing and tier breakpoint for one of tiered offer scenarios 46 via input element 32 (FIG. 1). Referring briefly to FIG. 1, computing system 20 receives tier pricing 52 in the form of first offer price 54 (OP1) for first tier 56, second offer price 58 for second tier 60, and tier breakpoint 62.

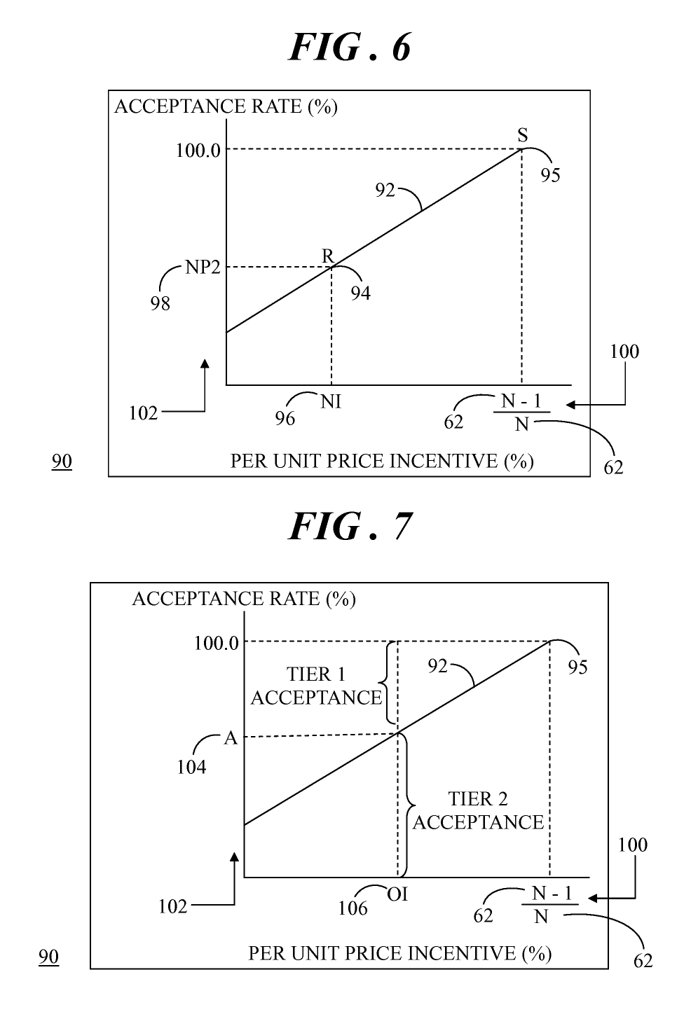

With reference back to FIG. 2, a task 88 is performed in response to task 86. At task 88, consumer acceptance (A) of the received one of tiered offer scenarios 46 is ascertained. Consumer acceptance (A) refers to the proportion of consumers that will purchase product 50 at the tier price, in this case first offer price 54 at first tier 56 or second offer price 58 at second tier 60. In general, a curve for consumer acceptance relative to a price incentive is computed. This curve is used to estimate the acceptance of the price incentive offered at second tier 60. Task 88 includes multiple operations and computations that are discussed in detail in connection with FIGS. 6-11.

FIG. 6 shows a graph 90 depicting an incentive curve 92 established through execution of the tiered offer forecasting process 40. In general, incentive curve 92 is a straight line and is determined from two points, i.e., a first incentive value 94 and a second incentive value 95. First incentive value 94, R, is calculated using a nominal incentive value 96 (NI) and a nominal probability value (NP2) 98 for second tier 60 (FIG. 1). First incentive value 94, R, indicates how frequently consumers were willing to purchase a quantity of N or more, i.e. the value of tier breakpoint 62, of product 50 under historical conditions. Computations for determining first incentive value 94 are discussed below.

Second incentive value 95, S, is based on a rational consumer assumption on tier breakpoint 62, N. Rational consumer assumption is the point at which an additional product 50 can be purchased for no additional cost to the consumer by purchasing product 50 at second offer price 58 (FIG. 1) of second tier 60 (FIG. 1) instead of first offer price 54 (FIG. 1) of first tier 56 (FIG. 1). For example, if second offer price 58 is at a 33.33% incentive when buying three or more units of product 50 (i.e., tier breakpoint 62 is three) then buying two units of product 50 at first offer price 54 is the same cost as buying three units of product 50 at second offer price 58. In other words, if two units of product 50 cost $1.00 each and three units of product 50 cost $0.67 each, the cost of two units ($2.00) is the same as the cost for three units ($2.00). At this point it is assumed that any rational consumer would buy three rather than two units of product 50. Thus, second incentive value 95 indicates where the rational consumer assumption drives consumer acceptance to 100%

Graph 90 is depicted as a two-dimensional line chart or line graph having a horizontal x-axis 100 and a vertical y-axis 102. X-axis 100 is used to plot per unit price incentive percentage and y-axis 102 is used to derive an acceptance rate value, i.e. as acceptance rate percentage. First incentive value 94 is calculated so that nominal incentive value 96 is the abscissa and nominal probability value 98 is the ordinate in the ordered pair for first incentive value 94. Nominal probability value 98 is bounded in the range of [0, (N−1)/N], where N is tier breakpoint 92. The upper limit, (N−1)/N, of the range is the abscissa and a consumer acceptance of 100% is the ordinate in the ordered pair for second incentive value 95.

In an embodiment, once first and second incentive values 94 and 95 are calculated and plotted in the two-dimensional line chart of graph 90, a straight line intersecting both of first and second incentive values 94 and 95 can be drawn. This straight line is incentive curve 92.

FIG. 7 shows graph 90 depicting use of incentive curve 92 to ascertain a consumer acceptance value 104 of one of tiered offer scenarios 46 (FIG. 1). Consumer acceptance value 104 defines consumer acceptance as a proportion of consumers willing to purchase product 50 at second offer price 58 (FIG. 1) for second tier 60 (FIG. 1). Once incentive curve 92 is known, curve 92 can be used to determine the expected consumer acceptance value 104. That is for any input incentive percentage, i.e., an offer incentive value 106, the corresponding consumer acceptance value 104, A, can be found as an intersection between incentive curve 92 and offer incentive value 106. Since incentive curve 92 is a straight line, A can be determined from the mathematical equation of a straight line, i.e., y=mx+b, where “x” is offer incentive value 106, and “y” is consumer acceptance value 104.

As can be seen in graph 90 of FIG. 7, consumer acceptance value 104 for one of tiered offer scenarios 46 (FIG. 1) goes down in response to a greater required purchase amount for product 50. As offer incentive value 106 increases, consumer acceptance value 104 increases (to 100% with rational consumer assumption taken into account). Consumer acceptance value 104 changes in a fashion consistent with historical purchase behavior observed under historical pricing circumstances (i.e., from purchase records 44). Furthermore, this approach enables forecasting for any two-tier offer scenario 46 (FIG. 1), even if historical empirical distribution is sparsely populated.

Thus, as represented in FIGS. 6 and 7, a curve for acceptance relative to price incentive can be computed, and this curve can be utilized to estimate the acceptance of the tier two price incentive, i.e., second offer price 58 for second tier 60 (FIG. 1).

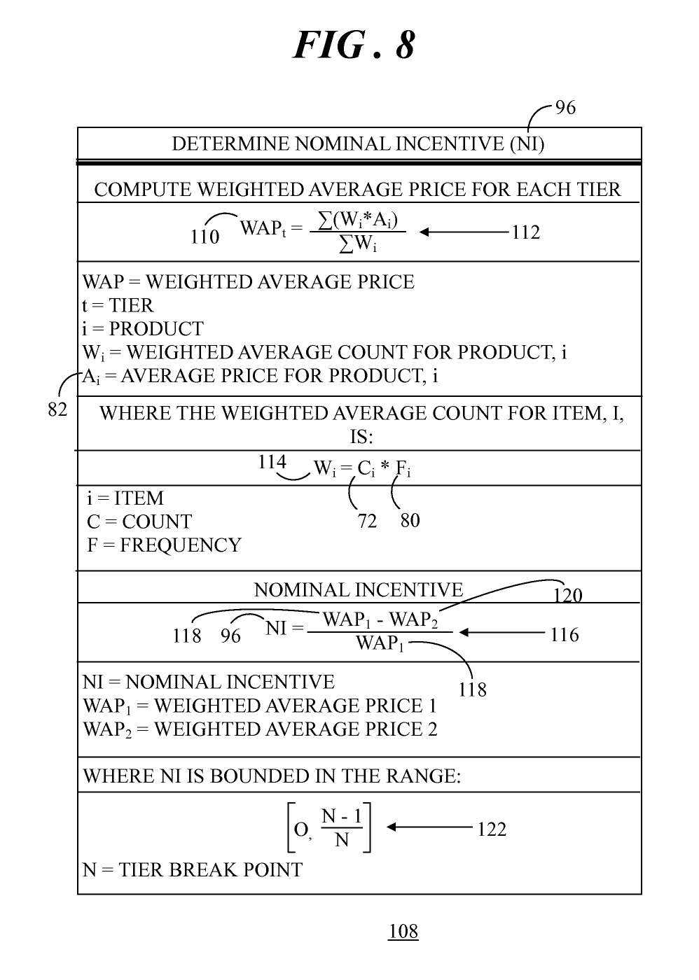

FIG. 8 shows a diagram 108 exemplifying computation of nominal incentive value 96, NI, in accordance with ascertaining task 88 (FIG. 2) of tiered offer forecasting process (66). In order to determine nominal incentive value 96, a weighted average price (WAP) 110 is determined for each of first and second tiers 56 and 60 (FIG. 1). The “weighted average price” is an average price of the various prices for sales of product 50 used in a particular tier that is weighted based on the number of units of product 50 that are sold. An equation 112 for determining weighted average price 110 is a function of a weighted average count 114, Wᵢ, for product 50 and an average unit price 82 (FIG. 3), where weighted average count 114 is a product of basket count 72, Cᵢ, and frequency 80, Fᵢ, for product 50.

An equation 116 for determining nominal incentive value 96 is thus a function of a first weighted average value 118 (WAP1) for first tier 54 (FIG. 1) and a second weighted average value 120 (WAP2) for second tier 60 (FIG. 1). As mentioned previously, nominal inventive value 96 is bound in a range 122 [0, (N−1)/N], where N is tier breakpoint 62 (FIG. 1). Accordingly nominal incentive value 96 uses first weighted average value 118 and a second weighted average value 120 (computed using historical data) corresponding to first and second tiers 54 and 60 instead of using offered prices (first and second offer prices 54 and 58).

When historical data, e.g., purchase records 44 (FIG. 3), are split into first and second tiers 56 and 60 and the average sale prices are examined in each tier, it is typically the case that retailers have reduced the sale prices for selling large quantities of product 50. The prices that were used for sales in those tier levels historically are used to compute a nominal incentive. Thus, nominal incentive value 96 represents an inherent basic incentive that is observed in the historical data when it has been divided into first and second tiers 56 and 60.

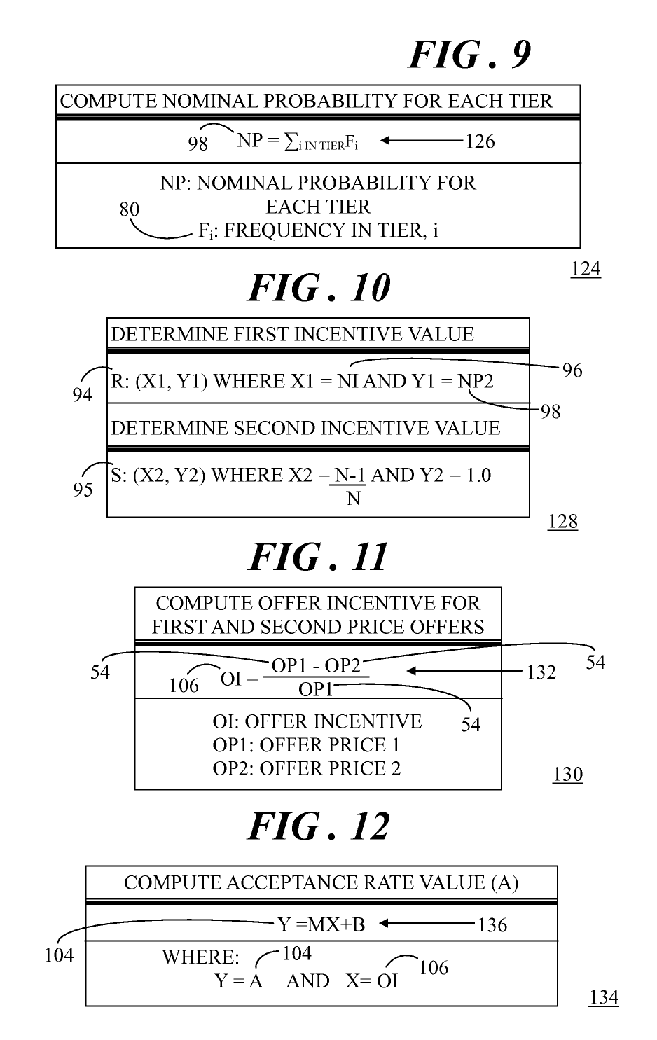

FIG. 9 shows a diagram 124 exemplifying computation of nominal probability value 98 in accordance with ascertaining task 88 (FIG. 2) of tiered offer forecasting process 66 (FIG. 2). Nominal probability value 98 for each of first and second tiers 56 and 60 is the sum of frequencies 80 in that tier. Thus, an equation 126 depicts the sum of frequencies 80 for a tier, i. Following computation of nominal incentive value 96 demonstrated in FIG. 8 and computation of nominal probability value 98 for second tier 60 demonstrated in FIG. 9, first incentive value 94 (FIG. 6) can be determined in order to derive incentive curve 92 (FIG. 6).

FIG. 10 shows a diagram 128 summarizing first and second inventive values 94 and 95, respectively, for determining incentive curve 92 (FIG. 6) in accordance with task 88 (FIG. 2) of tiered offer forecasting process 66 (FIG. 2). Nominal incentive value 96 forms the abscissa and nominal probability value 98 forms the ordinate in the ordered X, Y pair for first incentive value 94. (N−1)/N, i.e., the maximum in range 122 (FIG. 8), forms the abscissa and 1.0, i.e., 100 percent acceptance, forms the ordinate in the ordered X, Y pair for second incentive value 95.

FIG. 11 shows a diagram 130 exemplifying computation of offer incentive value 106 (FIG. 7) in accordance with ascertaining task 88 (FIG. 2) of tiered offer forecasting process 66 (FIG. 2). An equation 132 is a function of first and second offer prices 54 and 58. Offer incentive value 106 represents the monetary incentive for purchasing product 50 at tier two pricing (i.e. second offer price 58 for second tier 60) instead of tier one pricing (i.e. first offer price 54 for first tier 56).

FIG. 12 shows a diagram 134 summarizing computation of consumer acceptance value 104 in accordance with task 88 (FIG. 2) of tiered offer forecasting process 66 (FIG. 2). An equation 136 for incentive curve 92 (FIG. 6) is a linear equation where Y is the vertical coordinate, i.e., consumer acceptance value 104, M is the slope of incentive curve 92, X is the horizontal coordinate, i.e., offer incentive value 106, and B is the y intercept, i.e. the height at which incentive curve 92 crosses Y-axis 102 (FIG. 6).

With reference back to FIG. 2, the above description provided means for ascertaining consumer acceptance value 104 at task 88. Consumer acceptance value 104 is a value defining consumer acceptance as a proportion of consumers willing to purchase product 50 at second offer price 58 of said second tier 60. Following task 88, tiered offer forecasting process 66 continues with a task 138. At task 138, a weighted offer price is generated. The weighted offer price is a price for product 50 used for forecasting. In general, it is a weighted average of first offer price 54 (FIG. 1) for first tier 56 and second offer price 58 (FIG. 1) for second tier 60.

A task 139 is performed in response to task 138. At task 139, a sales forecast is computed for product 50 using the weighted offer price. At task 139, promotion forecasting code 64 (FIG. 1) may be executed to forecast a total quantity of units (Q) of product 50 that may sell using the weighted offer price as a single pricing tier. Thus, the weighted offer price is used for forecasting. Promotion forecasting code 64 may be realized as any of multiple existing or upcoming single price tier forecasting algorithms.

A task 140 is performed in connection with tasks 138 and 139. At task 140, weighting values for each of first tier 56 and second tier 60 are computed.

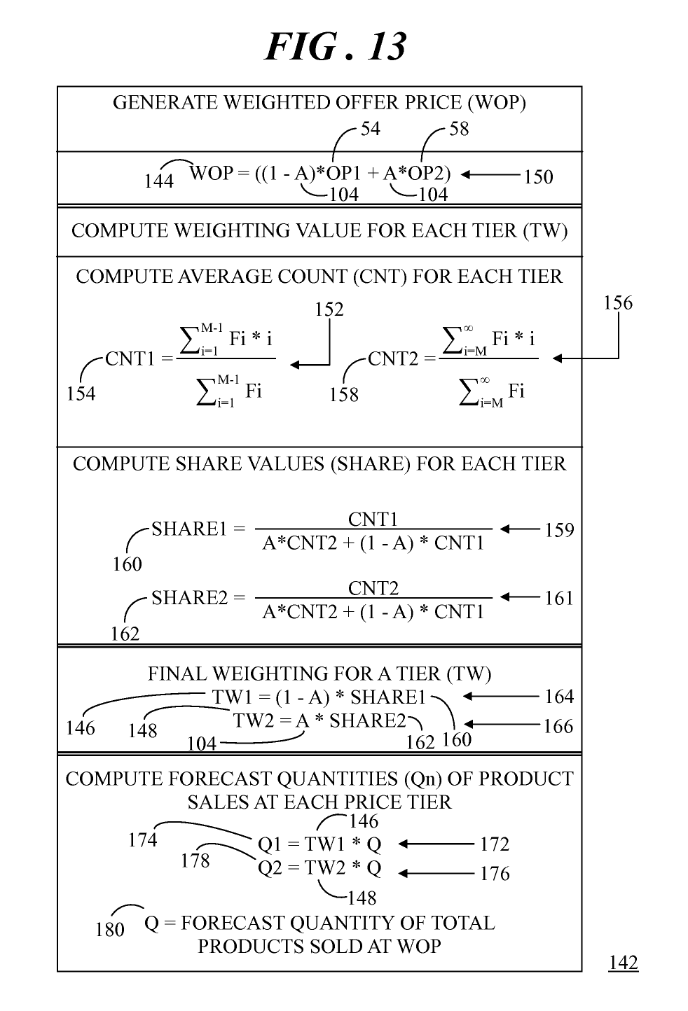

Referring to FIG. 13 in connection with tasks 138, 139, and 140, FIG. 13 shows a diagram 142 exemplifying generation of a weighted offer price 144 in accordance with task 138 of tiered offer forecasting process 66 (FIG. 2) and computing weighting values 146 and 148 in accordance with task 140 of tiered offer forecasting process 66.

An equation 150 is used to calculate weighted offer price 144 as a function of consumer acceptance value 104 and first and second offer prices 54 and 58. First and second offer prices 54 and 58 are weighted based on consumer acceptance value 104. Therefore, weighted offer price 144 is a weighted average of first and second offer prices 54 and 58. Weighted offer price 144 forecasts what the entire sales of product 50 will be using tiered offer scenario 46 (FIG. 1).

In order to compute weighting values 146 and 148, an average count (CNTi) for each of first and second tiers 56 and 60 is computed. A first equation 152 computes a first average count value 154 for first tier 56 and a second equation 156 computes a second average count value 158 for second tier 60.

Next, first and second share values 160 and 162, respectively, are computed for each of first and second tiers 56 and 60 using first and second average count values 154 and 158. Each of share values 160 and 162 represents a proportional share of the total sales expected to be purchased as sales at each of first tier 56 and second tier 60. In this example, a first equation 159 is used to compute first share value 160 as a function of first average count value 154, second average count value 158, and consumer acceptance value 104. Likewise, a second equation 161 is used to compute second share value 162 as a function of first average count value 154, second average count value 158, and consumer acceptance value 104.

Once first and second share values 160 and 162 are computed, first weighting value 146 is computed using first share value 160 and consumer acceptance value 104, as represented by an equation 164. Likewise, second weighting value 148 is computed using second share value 162 and consumer acceptance value 104, as represented by an equation 166.

Returning to tiered offer forecasting process 66 (FIG. 2) following task 140, process 66 continues with a task 168. At task 168, a first quantity of sales value (Q1) is forecast for product 50 at first offer price 54 (FIG. 1) for first tier 56.

A task 170 is performed in connection with task 168. At task 170, a second quantity of sales value (Q2) is forecast for product 50 at second offer price 58 (FIG. 1) for second tier 60.

Now referring back to FIG. 13, diagram 142 additionally depicts an equation 172 for computing a forecast first quantity of sales value 174 (Q1) and another equation 176 for computing a forecast second quantity of sales value 178 (Q2). Each of first and second quantity of sales values 174 and 178 is a product of a total quantity 180 (Q) of products 50 to be sold at the generated weighted offer price 144 and their respective first and second weighting values 146 and 148. Total quantity 180 was derived at task 139 using promotion forecasting code 64 (FIG. 1), as discussed above.

Referring back to tiered offer forecasting process 66 (FIG. 2), following task 170, process 66 continues with a task 182. At task 182, a sales forecast record, e.g., tiered offer 22 (FIG. 1) can be generated that includes at least forecast first and second quantity of sales values 174 and 178 (FIG. 13).

A task 184 is performed in connection with task 182. At task 182, computing system 20 (FIG. 1) provides, i.e., outputs, tiered offer 22 containing forecast first and second quantity of sales values 174 and 178. That is, tiered offer 22 contains first quantity of sales value 174, Q1, which is a prediction or forecast of sales of product 50 (FIG. 1) at first offer price 54 (FIG. 1) for first tier 56. Additionally, tiered offer 22 contains second quantity of sales value 178, Q2, which is a prediction or forecast of sales of product 50 (FIG. 1) at second offer price 58 (FIG. 1) for second tier 60.

Following task 184, tiered offer forecasting process 66 continues with a query task 186. At query task 186, a determination is made as to whether another iteration of process 66 should be performed using another tiered offer scenario 46 (FIG. 1). When another iteration is to be performed, program control loops back to task 86 so that computing system 20 receives tier pricing 52 (FIG. 1) and tier breakpoint 62 (FIG. 1) for another one of tiered offer scenarios 46 via input element 32 (FIG. 1), in order to ultimately derive another set of forecast first and second quantity of sales values 174 and 178 (FIG. 13). When a determination is made at task 86 that no further iterations need be performed, tiered offer forecasting process 66 ends. Thus, a pricing manager for a retailer can run multiple scenarios (variations of offer tiers, prices, and the like) to see which scenario might produce the best results in terms of consumer acceptance, product movement, and profitability. Furthermore, these forecasts can be determined by analyzing historical transaction data to produce an empirical distribution of basket counts and associated price/promotion data.

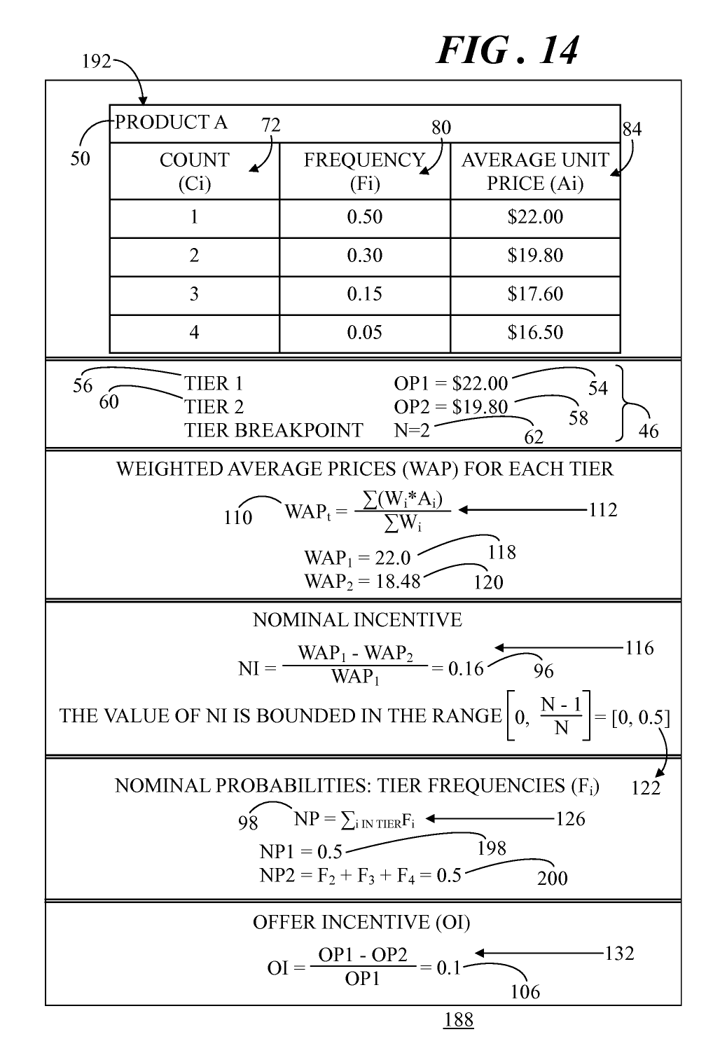

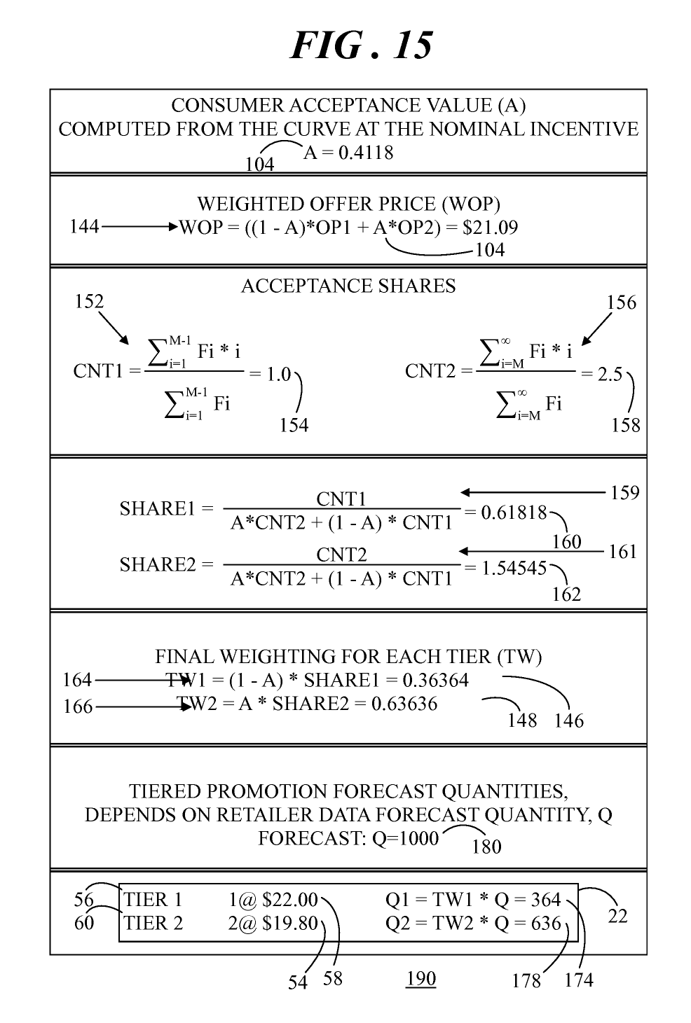

Referring now to FIGS. 14 and 15, FIG. 14 shows a diagram 188 demonstrating a portion of computations performed in accordance with tiered offer forecasting process 66 (FIG. 2) for an exemplary tiered offer scenario 46 (FIG. 1), and FIG. 15 shows a diagram 190 demonstrating a remaining portion of computations performed in accordance with tiered offer forecasting process 66 for the exemplary tiered offer scenario 46.

Diagram 188 includes processed purchase record data 192 of purchase records 44 (FIG. 1) having been received and processed in accordance with tasks 68 and 76 of tiered offer forecasting processed 66 (FIG. 2). Processed purchase record data 192 is an empirical count distribution of purchase records 44 sorted by basket count 72. At each basket count 72, frequency 80 and average unit price 84 for product 50 were computed as discussed above in connection with task 76.

In this example, tiered offer scenario 46 includes first offer price 54 for first tier 56 set to $22.00 and second offer price 58 for second tier 60 set to $19.80. This is a two-fer offer in which a consumer receives a price discount when purchasing two units of product 50. Therefore, tier breakpoint 62 is two, i.e., N=2.

Weighted average price 110 for each of first and second tiers 56 and 60 is computed using equation 112. Hence, in this example, first weighted average price 118 for first offer price 54 is $22.00 and second weighted average price 120 for second offer price 58 is $18.48. Once first and second weighted average prices 118 and 120 are computed, nominal incentive value 96 can be determined using equation 116. Thus, nominal incentive value 96, in this example, is 0.16 bounded in range 122 from 0 to 0.5.

Next, nominal probability value 98 can be calculated for each of first and second tiers 56 and 60, as the sum of the frequencies in that tier. Using frequencies 80 from processed purchase record data 192, a first nominal probability value 198 for first tier 56 is 0.50, and a second nominal probability value 200 for second tier 60 is also 0.50 (i.e., 0.30+0.15+0.05). Now, incentive curve 92 (FIG. 6) can be derived using nominal incentive value 96 of 0.16, second nominal probability 200 of 0.5, and the upper limit of range 122 of 0.5 as discussed above in connection with FIGS. 6 and 7.

Next, offer incentive value 106 of 0.1 can be calculated using equation 132 and inputting first offer price 54 and second offer price 58. Offer incentive value 106 is used to determine consumer acceptance value 104 as discussed above in connection with FIG. 7. Thus, continuing on diagram 190 (FIG. 15), consumer acceptance value 104 can be determined from equation 136 (FIG. 12) for a straight line. In this example, consumer acceptance value 104 (A) is 0.4118 in accordance with task 88 of tiered offer forecasting process 66 (FIG. 2). Next, weighted offer price 144 of $21.09 is computed using equation 104 in accordance with task 138 of tiered offer forecasting process 66.

First equation 152 is used to compute first average count value 154 of 1.0 for first tier 56 and second equation 156 is used to compute second average count value 158 of 2.5 for second tier 60. Next, equation 159 is used to compute first share value 160 of 0.61818 and equation 161 is used to compute second share value 162 of 1.54545. Once first and second share values 160 and 162 are computed, equation 164 is used to compute first weighting value 146 of 0.36364 using first share value 160 and consumer acceptance value 104, and equation 166 is used to compute second weighting value 148 of 0.63636 using second share value 162 and consumer acceptance value 104 in accordance with task 140 of tiered offer forecasting process 66 (FIG. 2).

Tiered promotion forecast quantities, i.e., first quantity of sales value 174, Q1, and second quantity of sales value 178, Q2, depend upon retailer data forecast quantity, i.e. total quantity 180 computed at task 139 using single tier pricing of weighted offer price 144. For simplicity of illustration, total quantity 180 is forecast to be one thousand units of product 50. Thus, first quantity of sales value 174, Q1, of 364 is a product of first weighting value 146 for first tier 56 and second quantity of sales value 178, Q2, of 636 is a product of second weighting value 148 for second tier 60. First and second sales forecast quantities 174 and 178 can be provided from computing system 20 as tiered offer 22.

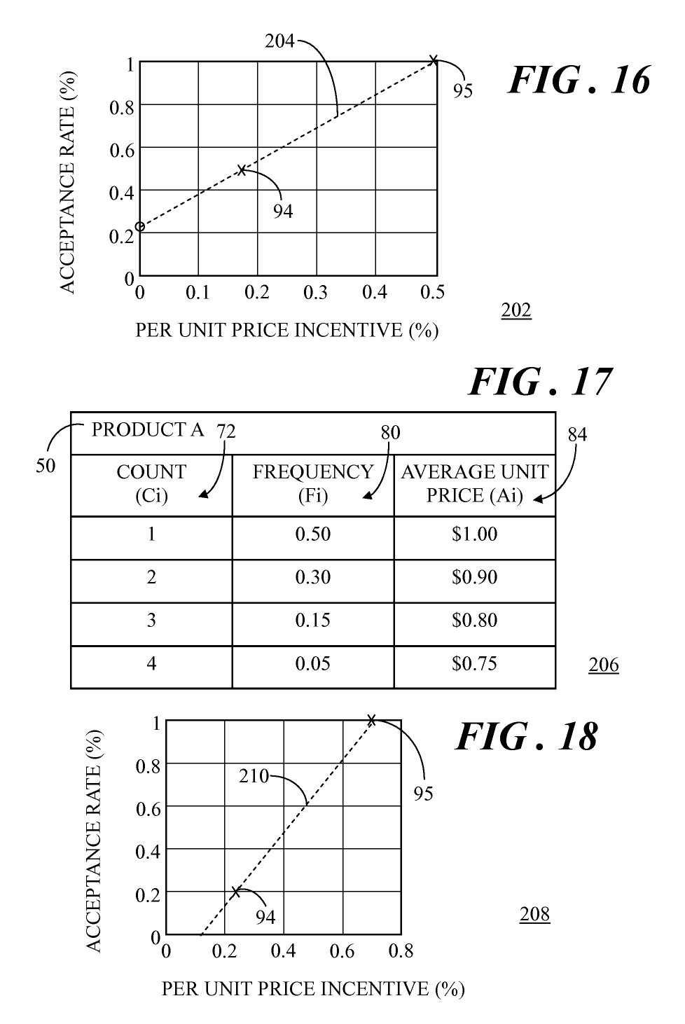

Referring to FIGS. 16-17, FIG. 16 shows a graph 202 depicting an incentive curve 204 in accordance with an example, and FIG. 17 shows a chart 206 of an empirical basket count distribution used to derive graph 202. First incentive value 94 is derived from the historical purchase data and reflects how frequently consumers were willing to accept (i.e., purchase) N-or-more (in this case, tier breakpoint 62 is N=2) of product 50 under historical conditions. Second incentive value 95 is based on the rational consumer assumption that every consumer (100%) will accept the higher tier's offer (second offer price 58 of second tier 60) when the incentive to purchase is great enough that it costs the consumer no additional money to purchase at the higher tier.

Referring now to FIG. 18, FIG. 18 shows a graph 208 depicting an incentive curve 210 in accordance with another example. In this example, chart 206 (FIG. 17) of empirical basket count purchase data was used again to project acceptance of a tiered offer scenario 46 (FIG. 1) requiring purchase of three units of product 50, i.e. tier breakpoint 62 is N=3. Note from graph 208, relative to graph 202, that the rational consumer assumption endpoint, represented by second incentive value 95, moves when the consumer must buy three products. That is, 66% is the discount for which a consumer who would normally only purchase one unit of product 50 can get all three units for no additional cost.

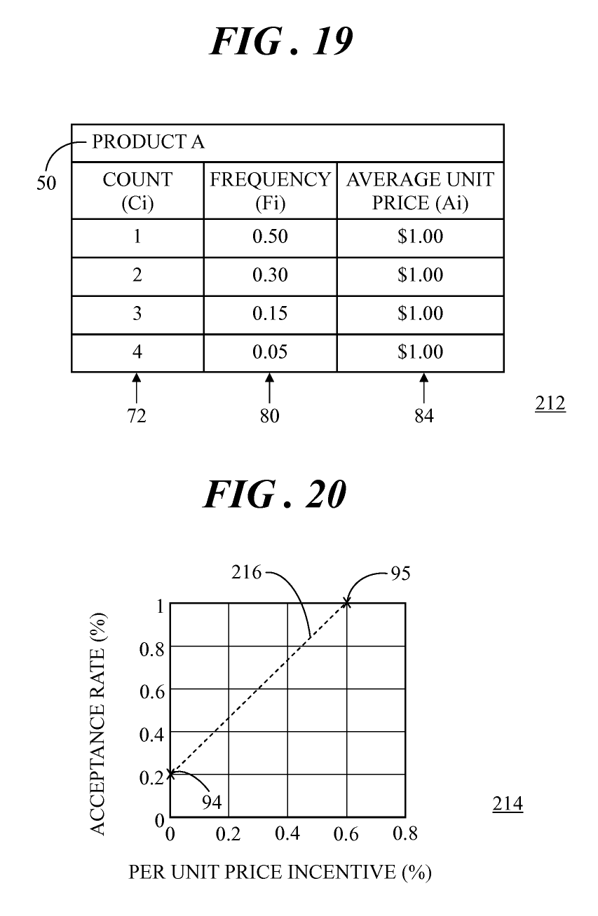

Referring to FIGS. 19 and 20, FIG. 19 shows a chart 212 of an empirical count distribution when there is no history of incentive at higher basket counts 72, and FIG. 20 shows graph 214 depicting an incentive curve 216 derived using the empirical count distribution of chart 212 and using a three-fer offer structure, in which a consumer receives a price discount when purchasing three units of product 50. In this example, there is no history of incentive at higher basket counts 72. Therefore, average unit price 84 is the same, e.g., $1.00, at each basket count 72. Note from graph 214 that there was no historical incentive to purchase multiple units of product 50. Therefore, first incentive value 94 is zero along the horizontal axis. Note also in this three-fer offer structure, that again 66% is the discount for which a consumer who would normally only purchase one unit of product 50 can get all three units for no additional cost. This rational consumer assumption is represented by second incentive value 95.

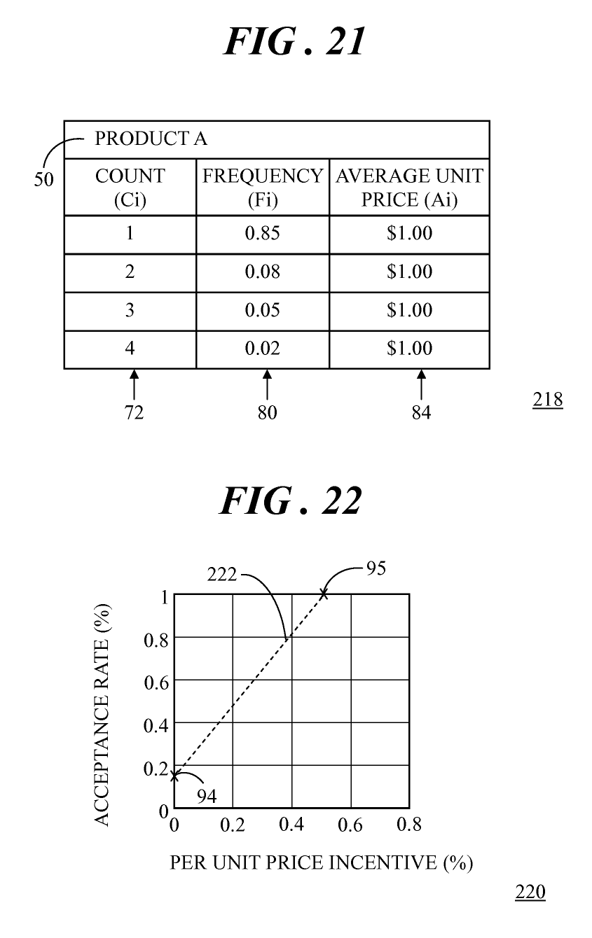

Referring to FIGS. 21 and 22, FIG. 21 shows a chart 218 of an empirical count distribution when there is no history of incentive at higher basket counts, and FIG. 22 shows graph 220 depicting an incentive curve 22 derived using the empirical count distribution of chart 218 (FIG. 21) and using a two-fer offer structure. Note from graph 220 that there was no historical incentive to purchase multiple units of product 50. Therefore, first incentive value 94 is zero along the horizontal axis. Note also in this two-fer offer structure, that 50% is the discount for which a consumer who would normally only purchase one unit of product 50 can get two units for no additional cost. This rational consumer assumption is represented by second incentive value 95.

In summary, embodiments entail a system, a computer-readable storage medium containing executable code, and methodology for predicting, i.e., forecasting, sales of a product in a tiered offer. In particular, the system and methodology entail an approach for forecasting of tiered offers. The approach calls for analyzing historical transaction data to produce an empirical distribution of basket counts and associated price/promotion data, and leveraging this historical transaction data to forecast quantities of products sold by offer tier, as a function of an offer incentive and purchase amount associated with each tier. In particular, incentive curves are generated using the historical transaction data. When forecasting with the incentive curves, calculations can be made for each product per store at each tier. The results are weighted by the consumer acceptance values for the tiers in order to forecast, or predict, a quantity of products that may be sold in response to the particular tiered offer. Retailers can use the knowledge of sales forecasting in a tiered offer to determine which tiered offer will increase consumer traffic and/or maximize profits, how much inventory to stock, what employment levels to maintain, and so forth.

Although the preferred embodiments of the invention have been illustrated and described in detail, it will be readily apparent to those skilled in the art that various modifications may be made therein without departing from the spirit of the invention or from the scope of the appended claims. For example, the process steps discussed herein can take on great number of variations and can be performed in a differing order from that which was presented.

What is claimed is:

1. A method of forecasting sales of a product in a tiered offer comprising:
receiving, at a computing system, purchase records for said product, each of said purchase records including a basket count and a unit price, said a basket count identifying a quantity of said product purchased, and said unit price identifying a purchase cost for said product;
receiving, at said computing system, tiered offer pricing for said tiered offer, said tiered offer pricing including a first offer price for said product at a first tier, a second offer price for said product at a second tier, and a tier breakpoint differentiating said first tier from said second tier;
ascertaining consumer acceptance of said first offer price at said first tier and said second offer price at said second tier using said basket count and said unit price included in said each of said purchase records;
utilizing said consumer acceptance to forecast a first quantity of sales of said product at said first offer price and to forecast a second quantity of said sales of said product at said second offer price; and
providing, from said computing system, said forecast first quantity of said sales of said product at said first offer price and said forecast second quantity of said sales of said product at said second offer price to a user for implementation in said tiered offer.

2. A method as claimed in claim 1 further comprising:
for each said basket count, computing a frequency of said purchase records containing said quantity of said product purchased;
for said each said basket count, computing an average unit price for said product from said unit price, wherein said ascertaining operation utilizes said frequency and said basket count computed from said purchase records to ascertain said consumer acceptance of said first and second offer prices.

3. A method as claimed in claim 1 wherein said second price offer reflects a reduction in said purchase cost of said product relative to said first price offer when more than one of said product is purchased during a purchase transaction.

4. A method as claimed in claim 1 wherein said tier breakpoint is a minimum basket count value for said second tier, and said ascertaining operation comprises:
computing an offer incentive value relative to said first and second offer prices, said offer incentive value indicating a monetary incentive for purchasing said product at said second offer price relative to said first offer price;
determining, from said purchase records, a first incentive value that defines a frequency at which consumers purchased at least said minimum basket count value of said product;
identifying a second incentive value that defines a point at which an additional one of said product can be purchased for no additional cost to said consumers at said second offer price;
establishing an incentive curve that intersects each of said first and second incentive values; and
utilizing said offer incentive and said incentive curve to ascertain said consumer acceptance.

5. A method as claimed in claim 4 wherein said tier breakpoint is a minimum basket count value for said second tier, and said determining operation comprises:
sorting said purchase records by said basket count such that said first tier contains a first set of said purchase records containing said quantity of said product purchased that is less than said tier breakpoint and said second tier contains a second set of said purchase records containing said quantity of said product purchased that is equivalent to or greater than said tier breakpoint;
determining a nominal probability value as a sum of said frequency at said each of said basket count in said second tier;
computing a first weighted average price of said product at said first tier using a frequency and an average unit price for each basket count in said first set of said purchase records, said frequency indicating a proportion of said purchase records containing said basket count and said average unit price being an average of said unit price for said product when purchased at said basket count;
computing a second weighted average price of said product at said second tier using said frequency and said average unit price for said each basket count in said second set of said purchase records;
computing a nominal incentive value using said first and second weighted average prices; and
using said nominal probability value and said nominal incentive value to determine said first incentive value.

6. A method as claimed in claim 4 wherein said establishing operation comprises:
plotting said first and second incentive values on a two dimensional line chart;
forming said incentive curve in said line chart;
plotting said offer incentive value in said line chart; and
identifying an acceptance rate value as an intersection of said offer incentive value and said incentive curve in said line chart, said acceptance rate value defining said consumer acceptance as a proportion of said consumers willing to purchase said product at said second offer price for said second tier.

7. A method as claimed in claim 1 wherein said ascertaining operation comprises determining an acceptance rate value, said acceptance rate value defining said consumer acceptance as a proportion of consumers willing to purchase said product at said second offer price for said second tier.

8. A method as claimed in claim 7 further comprising:
computing a weighted offer price for said tiered offer using said first offer price, said second offer price, and said acceptance rate value, said weighted offer price reflecting a single offer price for said product;
determining a total quantity of said product forecast to be purchased using said weighted offer price; and
computing said first quantity of said sales as a first portion of said total quantity; and
computing said second quantity of said sales as a second portion of said total quantity.

9. A method as claimed in claim 8 wherein said determining said total quantity comprises executing a promotion forecasting engine to forecast said total quantity using said weighted offer price as a single pricing tier.

10. A method as claimed in claim 8 wherein:
said computing said first quantity comprises:
computing a first share of total sales of said product forecast to be purchased at said first offer price of said first tier;
computing a first tier weighting value for said first tier using said first share; and
computing said first quantity as a product of said total quantity and said first tier weighting value; and
said computing said second quantity comprises:
computing a second share of said total sales of said product forecast to be purchased at said second offer price of said second tier;
computing a second tier weighting value for said second tier using said second share; and
computing said second quantity as a product of said total quantity and said second tier weighting value.

11. A method as claimed in claim 1 further comprising enabling a user to specify said first and second price offers and said tier breakpoint.

12. A system for forecasting sales of a product in a tiered offer comprising:
a processor;
a computer-readable storage medium; and
executable code recorded on said computer-readable storage medium for instructing said processor to perform operations comprising:
receiving purchase records for said product, each of said purchase records including a basket count and a unit price, said a basket count identifying a quantity of said product purchased, and said unit price identifying a purchase cost for said product;
for each said basket count, computing a frequency of said purchase records containing said quantity of said product purchased;
for said each said basket count, computing an average unit price for said product from said unit price;
receiving, at said computing system, tiered offer pricing for said tiered offer, said tiered offer pricing including a first offer price for said product at a first tier, a second offer price for said product at a second tier, and a tier breakpoint differentiating said first tier from said second tier;
ascertaining consumer acceptance of said first offer price at said first tier and said second offer price at said second tier using said frequency and said basket count, said ascertaining operation including determining an acceptance rate value, said acceptance rate value defining said consumer acceptance as a proportion of consumers willing to purchase said product at said second offer price for said second tier;
utilizing said consumer acceptance to forecast a first quantity of sales of said product at said first offer price and to forecast a second quantity of said sales of said product at said second offer price; and
providing, from said system, said forecast first quantity of said sales of said product at said first offer price and said forecast second quantity of said sales of said product at said second offer price to a user for implementation in said tiered offer.

13. A system as claimed in claim 12 wherein said executable code instructs said processor to perform further operations comprising:
computing a weighted offer price for said tiered offer using said first offer price, said second offer price, and acceptance rate value, said weighted offer price reflecting a single offer price for said product;
determining a total quantity of said product forecast to be purchased using said weighted offer price; and
computing said first quantity of said sales as a first portion of said total quantity; and
computing said second quantity of said sales as a second portion of said total quantity.

14. A system as claimed in claim 13 wherein said executable code instructs said processor to perform a further operation comprising executing a promotion forecasting engine to forecast said total quantity using said weighted offer price as a single pricing tier.

15. A system as claimed in claim 12 further comprising an input element coupled to said processor for receiving said first offer price, said second offer price, and said tier breakpoint from a user.

16. A system as claimed in claim 15 wherein said second price offer received from said user reflects a reduction in said purchase cost of said product relative to said first price offer when more than one of said product is purchased during a purchase transaction

17. A computer-readable storage medium containing executable code for forecasting sales of a product in a tiered offer, said executable code instructing a processor to perform operations comprising:
receiving purchase records for said product, each of said purchase records including a basket count and a unit price, said a basket count identifying a quantity of said product purchased, and said unit price identifying a purchase cost for said product;
for each said basket count, computing a frequency of said purchase records containing said quantity of said product purchased;
for said each said basket count, computing an average unit price for said product from said unit price,
receiving tiered offer pricing for said tiered offer, said tiered offer pricing including a first offer price for said product at a first tier, a second offer price for said product at a second tier, and a tier breakpoint differentiating said first tier from said second tier, said tier breakpoint defining a minimum basket count value for said second tier;
ascertaining consumer acceptance of said first offer price at said first tier and said second offer price at said second tier using said frequency and said average unit price, said ascertaining operation including:
computing an offer incentive value relative to said first and second offer prices, said offer incentive value indicating a monetary incentive for purchasing said product at said second offer price relative to said first offer price;
determining, from said purchase records, a first incentive value that defines a frequency at which consumers purchased at least said minimum basket count value of said product;
identifying a second incentive value that defines a point at which an additional one of said product can be purchased for no additional cost to said consumers at said second offer price;
establishing an incentive curve that intersects each of said first and second incentive values; and
utilizing said offer incentive and said incentive curve to ascertain said consumer acceptance;
utilizing said consumer acceptance to forecast a first quantity of sales of said product at said first offer price and to forecast a second quantity of said sales of said product at said second offer price; and
providing, from said computing system, said forecast first quantity of said sales of said product at said first offer price and said forecast second quantity of said sales of said product at said second offer price to a user for implementation in said tiered offer.

18. A computer-readable storage medium as claimed in claim 17 wherein said executable code instructs said processor to perform further operations of said determining operation comprising:
sorting said purchase records by said basket count such that said first tier contains a first set of said purchase records containing said quantity of said product purchased that is less than said tier breakpoint and said second tier contains a second set of said purchase records containing said quantity of said product purchased that is equivalent to or greater than said tier breakpoint;
determining a nominal probability value as a sum of said frequency at said each of said basket count in said second tier;
computing a first weighted average price of said product at said first tier using a frequency and an average unit price for each basket count in said first set of said purchase records, said frequency indicating a proportion of said purchase records containing said basket count and said average unit price being an average of said unit price for said product when purchased at said basket count;
computing a second weighted average price of said product at said second tier using said frequency and said average unit price for said each basket count in said second set of said purchase records;
computing a nominal incentive value using said first and second weighted average prices; and
using said nominal probability value and said nominal incentive value to determine said first incentive value.

19. A computer-readable storage medium as claimed in claim 17 wherein said executable code instructs said processor to perform operations of said establishing operation comprising:
plotting said first and second incentive values on a two dimensional line chart;
forming said incentive curve in said line chart;
plotting said offer incentive value on said line chart; and
identifying an acceptance rate value as an intersection of said offer incentive value and said incentive curve in said line chart, said acceptance rate value defining said consumer acceptance as a proportion of said consumers willing to purchase said product at said second offer price for said second tier.

20. A computer-readable storage medium as claimed in claim 19 wherein said executable code instructs said processor to perform further operations comprising:
computing a weighted offer price for said tiered offer using said first offer price, said second offer price, and said acceptance rate value, said weighted offer price reflecting a single offer price for said product;
determining a total quantity of said product forecast to be purchased using said weighted offer price; and
computing said first quantity of said sales as a first portion of said total quantity; and
computing said second quantity of said sales as a second portion of said total quantity.
